(19) United States
(12) Patent Application Publication
(10) Pub. No.: US 2026/0251583 A1
(43) Pub. Date: Aug. 27, 2026

(54) PATTERN INSPECTION APPARATUS AND PATTERN INSPECTION METHOD

(71) Applicant: NuFlare Technology, Inc., Yokohama-shi (JP)

(72) Inventor: Yasuhiro YAMASHITA, Chigasaki-shi (JP)

(73) Assignee: NuFlare Technology, Inc., Yokohama-shi (JP)

(21) Appl. No.: 19/440,809

(22) Filed: Jan. 6, 2026

(30) Foreign Application Priority Data
Feb. 27, 2025 (JP) 2025-030278

(51) Int. Cl. G01N 21/956

(52) U.S. Cl. CPC G01N 21/956; G01N 2021/95676

(57) ABSTRACT

According to one aspect of the present invention, a pattern inspection apparatus includes an angle calculation circuit configured to calculate an adjustment angle for a ½ wave plate based on which a ratio between a light intensity of a first incident light entering a first light intensity sensor and a light intensity of a second incident light entering a second light intensity sensor becomes a desired ratio; and a transmittance calculation circuit configured to calculate a transmittance of a neutral density filter based on which a light intensity of the first incident light entering the first light intensity sensor becomes a value within a desired range set for the first light intensity sensor and a light intensity of the second incident light entering the second light intensity sensor becomes a value within a desired range set for the second light intensity sensor.

### CROSS-REFERENCE TO RELATED APPLICATION

This application is based upon and claims the benefit of priority from prior Japanese Patent Application No. 2025-030278 filed on Feb. 27, 2025 in Japan, the entire contents of which are incorporated herein by reference.

### BACKGROUND OF THE INVENTION

### Field of the Invention

Embodiments of the present invention relate to a pattern inspection apparatus and a pattern inspection method. For example, they relate to an inspection apparatus which inspects defects of a pattern formed on the substrate.

### Description of Related Art

With recent progress in high integration and large capacity of the LSI (Large Scale Integrated circuits), the line width (critical dimension) necessary for circuits of semiconductor elements is further decreasing. Such semiconductor elements are manufactured through circuit forming processing by exposing and transferring a pattern onto a wafer by means of a reduced projection exposure apparatus known as a stepper, using an original or “master” pattern (also called a mask or a reticle, hereinafter generically referred to as a mask) on which a circuit pattern has been formed.

Since LSI manufacturing needs an enormous production cost, it is essential to improve the yield. One of major factors that decrease the yield is due to pattern defects, such as a pattern shape defect and/or pattern dimension defect, on a mask used for exposing/transferring an ultrafine pattern onto a semiconductor wafer by the photolithography technology. In recent years, with miniaturization of dimensions of LSI patterns formed on a semiconductor wafer, dimensions to be detected as a pattern defect have become extremely small. Therefore, the pattern inspection apparatus for inspecting defects of a transfer mask used in manufacturing LSI needs to be highly accurate.

As an inspection method, for example, there is “die-to-die inspection” or “die-to-database inspection”. The “die-to-die inspection” method compares data of optical images of identical patterns at different positions on the same mask. The “die-to-database inspection” method inputs, into an inspection apparatus, writing data (design data) generated by converting pattern-designed CAD data to a writing-apparatus-specific format to be input to the writing apparatus when a pattern is written on the mask, generates a reference image based on the input writing data, and compares the generated reference image with an optical image being measured data obtained by imaging the pattern.

In an inspection apparatus, several system types of inspection are sometimes performed, such as the case of a transmission inspection using a transmission light having passed through a target object and a reflection inspection using a reflection light reflected from the target object, the case of a transmission inspection using one of a plurality of lights with different polarization directions and a transmission inspection using the other ones of the plurality of lights, and the case of a reflection inspection using one of a plurality of lights with different polarization directions and a reflection inspection using the other ones of the plurality of lights. In that case, for acquiring respective optical images with a desired accuracy in order to perform each system type inspection, it is necessary to adjust a light intensity (light quantity) to enter an optical image sensor of each system type. A plurality of inspection lights used for executing the several system type inspections are generated by branching a light emitted from one light source. A method has been conventionally employed where, while changing conditions, the light intensity entering each image sensor is adjusted by repeating setting an optical element and acquiring an image based on the setting until desired conditions are obtained. For this reason, there has been a problem that the time for light intensity calibration processing takes long, and the setup time before inspection processing becomes long. Thereby, the inspection throughput is degraded. Furthermore, since image acquisition performed a plurality of times repeatedly apply laser beams (lights) of high energy with a short wavelength to a target object, patterns formed on the target object may be damaged. Accordingly, it is needed to reduce the calibration processing time for the light intensity incident on each image sensor.

There is disclosed that the power ratio between a P-polarized component and an S-polarized component is changed by adjusting the angle for the λ/2 wave plate (e.g., refer to Japanese Patent Application Laid-open (JP-A) No. 2000-084682).

### BRIEF SUMMARY OF THE INVENTION

According to one aspect of the present invention, a pattern inspection apparatus includes
a stage configured to place thereon a target object on which a pattern is formed;
a light source;
a neutral density filter configured to attenuate a light intensity of a light emitted from the light source to any level;
a ½ wave plate configured to adjust a polarization direction of a light having passed through the neutral density filter;
a branch element configured to branch a light having passed through the ½ wave plate;
a first image sensor configured to acquire a first optical image of the target object which is irradiated with a first inspection light being one of two lights generated because of being branched;
a second image sensor configured to acquire a second optical image of the target object which is irradiated with a second inspection light being another one of the two lights generated because of being branched;
a first light intensity sensor configured to measure a light intensity of a first incident light entering the first image sensor;
a second light intensity sensor configured to measure a light intensity of a second incident light entering the second image sensor;
an angle calculation circuit configured to calculate an adjustment angle for the ½ wave plate based on which a ratio between a light intensity of the first incident light entering the first light intensity sensor and a light intensity of the second incident light entering the second light intensity sensor becomes a desired ratio;
a transmittance calculation circuit configured to calculate a transmittance of the neutral density filter based on which a light intensity of the first incident light entering the first light intensity sensor becomes a value within a desired range set for the first light intensity sensor and a light intensity of the second incident light entering the second light intensity sensor becomes a value within a desired range set for the second light intensity sensor; and
a comparison circuit configured to compare the first optical image with a first predetermined image, and compare the second optical image with a second predetermined image.

According to another aspect of the present invention, a pattern inspection method includes
attenuating, using a neutral density filter, a light intensity of a light emitted from a light source to any level,
adjusting, using a ½ wave plate, a polarization direction of a light having passed through the neutral density filter,
branching, using a branch element, a light having passed through the ½ wave plate,
measuring, using a first light intensity sensor, a light intensity of a first incident light which was emitted from the light source and enters a first image sensor via the neutral density filter, the ½ wave plate, the branch element, and a target object, placed on a stage, with a formed pattern,
measuring, using a second light intensity sensor, a light intensity of a second incident light which was emitted from the light source and enters a second image sensor via the neutral density filter, the ½ wave plate, the branch element, and the target object,
calculating an adjustment angle for the ½ wave plate based on which a ratio between a light intensity of the first incident light entering the first light intensity sensor and a light intensity of the second incident light entering the second light intensity sensor becomes a desired ratio,
calculating a transmittance of the neutral density filter based on which a light intensity of the first incident light entering the first light intensity sensor becomes a value within a desired range set for the first light intensity sensor and a light intensity of the second incident light entering the second light intensity sensor becomes a value within a desired range set for the second light intensity sensor,
acquiring, using the first image sensor, a first optical image of the target object irradiated with a first inspection light being one of two lights generated because of being branched, by the branch element, from a light having passed through the neutral density filter for which a calculated transmittance has been set and the ½ wave plate where a calculated adjustment angle has been set,
acquiring, using the second image sensor, a second optical image of the target object irradiated with a second inspection light being another one of the two lights generated because of being branched, by the branch element, from the light having passed through the neutral density filter for which the calculated transmittance has been set and the ½ wave plate where the calculated adjustment angle has been set, and
comparing the first optical image with a first predetermined image, and the second optical image with a second predetermined image, and outputting a result.

### BRIEF DESCRIPTION OF THE DRAWINGS

FIG. 1 is an illustration showing a configuration of a pattern inspection apparatus according to a first embodiment;

FIG. 2 is a conceptual diagram illustrating an inspection region according to the first embodiment;

FIG. 3 is an illustration explaining an example of a method for generating two inspection lights according to the first embodiment;

FIG. 4 is an illustration showing an example before and after light intensity adjustment according to the first embodiment;

FIG. 5 is a flowchart of a light intensity adjustment method according to a comparative example of the first embodiment;

FIG. 6 is a block diagram showing an example of the internal configuration of a light intensity adjustment circuit according to the first embodiment;

FIG. 7 is a flowchart showing an example of main steps of an inspection method according to the first embodiment;

FIG. 8 is an illustration showing an example of a light intensity at an initial condition according to the first embodiment;

FIG. 9 is a graph showing an example of a relationship between a transmission light intensity ratio and a reflection light intensity ratio adjusted by the λ/2 wave plate according to the first embodiment;

FIG. 10 is a diagram illustrating filter processing according to the first embodiment; and

FIG. 11 is an illustration showing an example of the internal configuration of a comparison circuit according to the first embodiment.

### DETAILED DESCRIPTION OF THE INVENTION

Embodiments of the present invention provide an inspection apparatus and method that can reduce a calibration processing time for a light intensity (light quantity) incident on an image sensor of each system type.

### First Embodiment

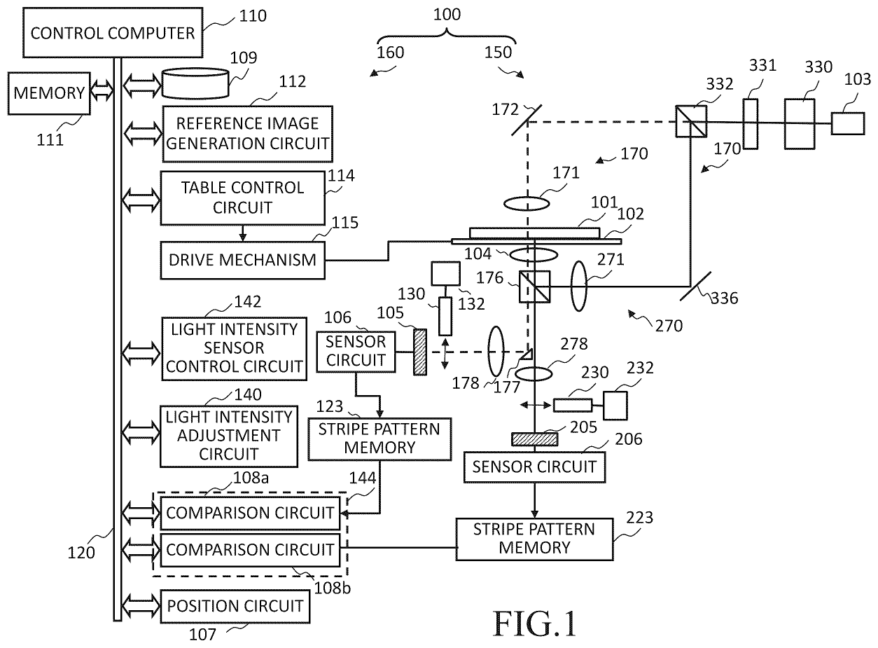

FIG. 1 is an illustration showing a configuration of a pattern inspection apparatus according to a first embodiment. As shown in FIG. 1, an inspection apparatus 100 that inspects defects of a pattern formed on a substrate 101 (example of an inspection target substrate) includes an optical image acquisition mechanism 150 and a control system circuit 160 (control unit).

The optical image acquisition mechanism 150 includes a light source 103 generating laser beams (lights), an ND (neutral density) filter 330, a λ/2 wave plate 331, a polarizing beam splitter 332 (an example of a branch element), a transmission illumination optical system 170, a reflection illumination optical system 270, an XYθ table 102, an objective lens 104, a beam splitter 176, a mirror 177, an image forming optical system 178, an image forming optical system 278, a light intensity sensor 130, a drive mechanism 132, an image sensor 105, a sensor circuit 106, a stripe pattern memory 123, a light intensity sensor 230, a drive mechanism 232, an image sensor 205, a sensor circuit 206, and a stripe pattern memory 223.

FIG. 1 shows an example of a configuration in which a transmission inspection and a reflection inspection can be performed as inspection of two system types.

The transmission illumination optical system 170 is configured by one or a plurality of lenses and/or one or a plurality of mirrors. In the case of FIG. 1, the transmission illumination optical system 170 includes a mirror 172 and a lens 171.

The reflection illumination optical system 270 is configured by one or a plurality of lenses and/or one or a plurality of mirrors. In the case of FIG. 1, the reflection illumination optical system 270 includes a mirror 336 and a lens 271.

On the XYθ table 102, the substrate 101 conveyed from an autoloader (not shown) is placed. The substrate 101 is, for example, an exposure photomask used for transfer printing a pattern onto a semiconductor substrate such as a wafer. A plurality of figure patterns to be inspected are formed on the photomask. The substrate 101 is disposed, for example, with its pattern forming surface facing downward, on the XYθ table 102.

As the image sensor 105 or 205, it is preferable to use a TDI (time delay integration) sensor, for example. The TDI sensor includes a plurality of photo sensor elements arranged two-dimensionally. When an image is acquired by each photo sensor element, a predetermined image accumulation time (or referred to as a scan time, and the same applies below) is set. In the TDI sensor, outputs of a plurality of photo sensor elements aligned in a scanning direction are integrated to be output. The plurality of photo sensor elements aligned in a scanning direction acquire images of the same pixel while shifting the time according to the movement of the XYθ table 102.

In the control system circuit 160, a control computer 110 which controls the whole of the inspection apparatus 100 is connected, through a bus 120, to a magnetic disk drive 109, a memory 111, a position circuit 107, a comparison circuit unit 144 (comparison circuits 108a and 108b), a reference image generation circuit 112, a table control circuit 114, a light intensity adjustment circuit 140, and a light intensity sensor control circuit 142. In the comparison circuit unit 144, a plurality of comparison circuits 108a and 108b are arranged.

The XYθ table 102 is driven by a drive mechanism 115. The drive mechanism 115 has an X-axis motor, a Y-axis motor, and a θ-axis motor, for example. Thus, the XYθ table 102 is driven by the X-axis motor, the Y-axis motor, and the θ-axis motor. The XYθ table 102 is an example of the stage.

For example, a linear motor can be used as each of the X-axis, Y-axis, and θ-axis motors. The XYθ table 102 is movable in the horizontal direction and the rotation direction by the X-, Y-, and θ-axis motors. The XYθ table 102 is adjusted, under the control of the control computer 110, to be at the focus position (optical axis direction: Z-axis direction) where the pattern-forming surface of the substrate 101 and the image sensors 105 and 205 are focused. The movement position of the substrate 101 placed on the XYθ table 102 is measured by a laser length measuring system (not shown) and supplied to the position circuit 107.

The drive mechanism 132 drives the light intensity sensor 130, and moves the light intensity sensor 130 between the inside and the outside of the optical axis of a light entering the image sensor 105. Similarly, the drive mechanism 232 drives the light intensity sensor 230, and moves the light intensity sensor 230 between the inside and the outside of the optical axis of a light entering the image sensor 205.

Each “ . . . circuit”, such as the position circuit 107, the comparison circuit 108, the reference image generation circuit 112, the table control circuit 114, the light intensity adjustment circuit 140, and the light intensity sensor control circuit 142, includes processing circuitry. The processing circuitry includes, for example, an electric circuit, computer, processor, circuit board, quantum circuit, semiconductor device, or the like. The same processing circuitry may be used for each “circuit”. For example, each “ . . . circuit”, such as the position circuit 107, the comparison circuit 108, the reference image generation circuit 112, the table control circuit 114, the light intensity adjustment circuit 140, and the light intensity sensor control circuit 142, may be configured and executed by the control computer 110. Alternatively, different processing circuitry (separate processing circuitry) may be used for each “circuit”. Input data necessary for the position circuit 107, the comparison circuit 108, the reference image generation circuit 112, the table control circuit 114, the light intensity adjustment circuit 140, and the light intensity sensor control circuit 142 and operated (calculated) results are stored in a memory (not shown) in each circuit or in the memory 111 each time. Input data necessary for the control computer 110 and operated (calculated) results are stored in a memory (not shown) in the control computer 110, or in the memory 111 each time. A program for causing a computer, processor or the like to execute processing may be stored in a recording medium, such as the magnetic disk drive 109 or the like.

In the inspection apparatus 100, a transmission inspection optical system with high magnification M1 is configured by the light source 103, the ND filter 330, the λ/2 wave plate 331, the polarizing beam splitter 332, the transmission illumination optical system 170, the XYθ table 102, the objective lens 104, the beam splitter 176, the mirror 177, the image forming optical system 178, the image sensor 105 and the sensor circuit 106. As the magnification M1, an inspection optical system with magnification of, for example, 200 to 300 times is configured.

Similarly, in the inspection apparatus 100, a reflection inspection optical system with high magnification M1 is configured by the light source 103, the ND filter 330, the λ/2 wave plate 331, the polarizing beam splitter 332, the reflection illumination optical system 270, the XYθ table 102, the objective lens 104, the beam splitter 176, the mirror 177, the image forming optical system 278, the image sensor 205 and the sensor circuit 206. As the magnification M1, an inspection optical system with magnification of, for example, 200 to 300 times is configured.

Writing data (design data) used as a basis for forming patterns on the inspection substrate 101 is input from the outside of the inspection apparatus 100, and stored in the magnetic disk drive 109. The writing data defines a plurality of figure patterns, and each figure pattern is usually configured by combining a plurality of element figures. Such a figure pattern may be configured by one figure. Then, each pattern corresponding to and based on each figure pattern defined by the writing data is formed on the inspection substrate 101.

FIG. 1 shows configuration elements necessary for describing the first embodiment. It should be understood that other configuration elements generally necessary for the inspection apparatus 100 may also be included therein.

The light source 103 emits, as an inspection illumination light, a laser beam (e.g., DUV light) (example of ultraviolet light) with a wavelength of about 190 to 200 nm, for example. The laser beam emitted from the light source 103 is attenuated by the ND filter 330, and its polarization direction is adjusted by the λ/2 wave plate 331. The ND filter 330 can arbitrarily attenuate the light intensity of laser beams to any level. The laser beam 301 whose polarization direction has been adjusted branches according to a polarization direction by the polarizing beam splitter 332, and two inspection lights, e.g., P-wave component light and S-wave component light, are generated.

In transmission inspection, an inspection light for transmission inspection, which has been branched by the polarizing beam splitter 332, is reflected by the mirror 172 to illuminate the substrate 101 by the lens 171. The transmission light having transmitted through the substrate 101 passes through the beam splitter 176 via the objective lens 104, and is reflected by the mirror 177, for example, to be focused/formed as an optical image (transmission image) incident on the image sensor 105 by the image forming optical system 178. In this way, the image sensor 105 images the transmission image. In FIG. 1, the inspection light for transmission inspection and the optical axis of an image are shown by dotted lines.

A pattern image focused/formed on the image sensor 105 is photoelectrically converted by each photosensor element of the image sensor 105, and a value after integration of a plurality of photosensor elements aligned in a scanning direction is output to the sensor circuit 106. Then, the value is analog-to-digital (A/D) converted by the sensor circuit 106.

In reflection inspection, an inspection light for reflection inspection, which has been branched by the polarizing beam splitter 332, is reflected by the mirror 336 and led to the beam splitter 176 by the lens 271. Then, the light reflected from the beam splitter 176 is applied to the substrate 101 by the objective lens 104. In other words, the illumination optical system configured by the reflection illumination optical system 270, the beam splitter 176, and the objective lens 104 illuminates the inspection substrate 101 with patterns formed thereon. The reflection light reflected from the substrate 101 passes through the objective lens 104 and the beam splitter 174, and is focused/formed to be an optical image (reflection image) incident on the image sensor 205 by the image forming optical system 278. In this way, the image sensor 205 images the reflection image.

A pattern image focused/formed on the image sensor 205 is photoelectrically converted by each photosensor element of the image sensor 205, and a value after integration of a plurality of photosensor elements aligned in a scanning direction is output to the sensor circuit 206. Then, the value is analog-to-digital (A/D) converted by the sensor circuit 206.

The transmission inspection and the reflection inspection may be executed simultaneously or independently. Alternatively, only one of the inspections may be performed.

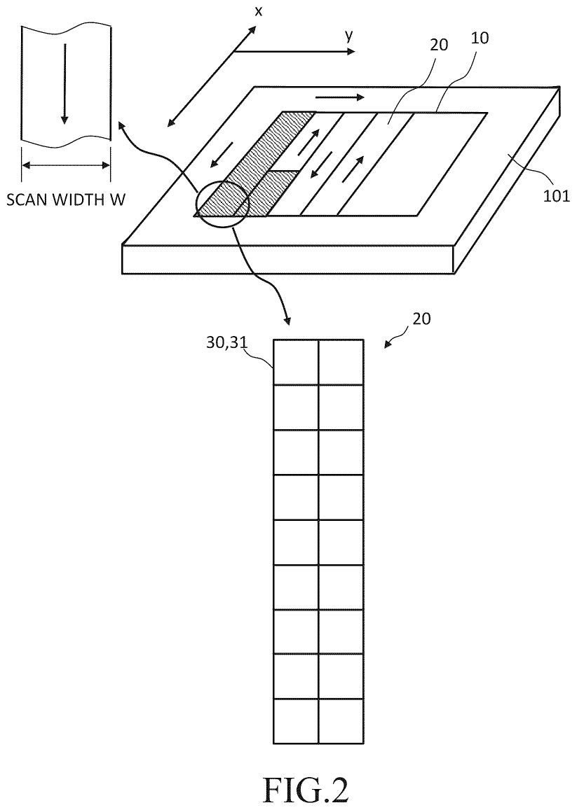

FIG. 2 is a conceptual diagram illustrating an inspection region according to the first embodiment. As shown in FIG. 2, an inspection region 10 (the entire inspection region) of the substrate 101 is virtually divided into a plurality of strip-shaped inspection stripes 20 each having a width W in the y direction, for example, which is the scan width of the image sensor 105 (205). The inspection apparatus 100 acquires an image (stripe region image) of each inspection stripe 20. Specifically, with respect to each of the inspection stripes 20, the inspection apparatus 100 captures/acquires an image of a figure pattern arranged in the inspection stripe 20 concerned, with a laser light (inspection light), imaging in the longitudinal direction (the x direction) of the stripe region concerned. In order to prevent a missing image, it is preferable that a plurality of inspection stripes 20 are set such that adjacent inspection stripes 20 overlap with each other by a predetermined margin width.

Each of the image sensors 105 and 205 acquires an optical image while relatively moving in the x direction continuously by the movement of the XYθ table 102. The image sensors 105 and 205 continuously capture optical images each having the scan width W as shown in FIG. 2. In other words, each of the image sensors 105 and 205 acquires an optical image on the surface of the substrate 101 with a plurality of figure patterns formed thereon while relatively moving in the integration direction of the image sensor 105 or 205. According to the first embodiment, after capturing/acquiring an optical image in one inspection stripe 20, the image sensor 105 (or 205) relatively moves in the y direction to the position of the next inspection stripe 20, and similarly captures another optical image having the scan width W continuously while moving in the direction reverse to the last image capturing direction. Thereby, the image acquiring is repeated in the forward (FWD) and backward (BWD) directions, namely changing the direction reversely when advancing and returning.

In an actual inspection, as shown in FIG. 2, the stripe region image of each inspection stripe 20 is divided into images of a plurality of rectangular (including square) frame regions 30. Then, inspection is performed for each image of the frame region 30. For example, it is divided into the size of 1024×1024 pixels. Therefore, a reference image to be compared with a frame image 31 of the frame region 30 is similarly generated for each frame region 30.

The direction of image capturing is not limited to repeating the forward (FWD) and backward (BWD) movement. Images may be captured in a fixed one direction. For example, FWD and FWD may be repeated, or alternatively, BWD and BWD may be repeated.

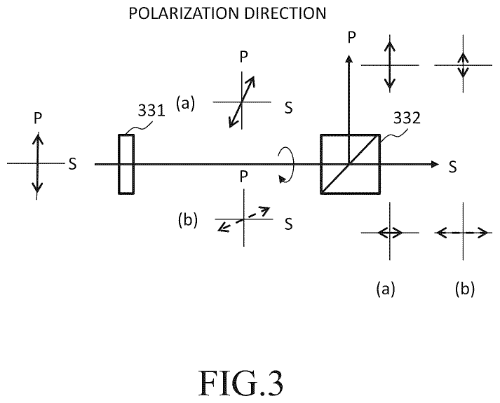

FIG. 3 is an illustration explaining an example of a method for generating two inspection lights according to the first embodiment. For convenience, FIG. 3 illustrates the case where, on the plane perpendicular to the optical axis of a laser beam entering the λ/2 wave plate 331, the light whose polarization direction is 0° is shown as an S wave, and that whose polarization direction is 90° is shown as a P wave. The laser beam emitted from the light source 103 (or the laser beam passing through an unshown optical element) is generated as a linearly polarized laser beam. In the case of FIG. 3, for example, a laser beam in a polarization direction of 90° (P wave) is generated on the plane perpendicular to the optical axis, and passes through the ND filter 330 to be incident on the λ/2 wave plate 331. The polarization direction of the laser beam is changed by altering the angle for the λ/2 wave plate 331. The example of FIG. 3 shows a polarization direction (a) where the P wave component having been adjusted to be an angle larger than 45° is larger on the plane perpendicular to the optical axis. Also, FIG. 3 shows a polarization direction (b) where the S wave component having been adjusted to be an angle smaller than 45° is larger on the plane perpendicular to the optical axis. When the laser beam whose polarization direction has been adjusted enters the polarizing beam splitter 332, the polarizing beam splitter 332 makes one of the P wave component and the S wave component transmit therethrough and the other reflected. FIG. 3 shows the case where the P wave component is made to be reflected and the S wave component is made to pass therethrough. In the polarization direction (a), the reflected P wave component becomes large and the S wave component becomes small. In the polarization direction (b), the reflected S wave component becomes large and the P wave component becomes small.

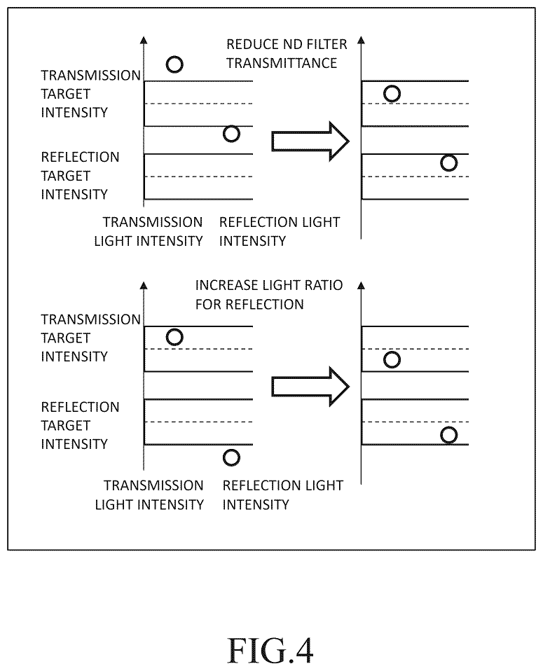

FIG. 4 is an illustration showing an example before and after light intensity adjustment according to the first embodiment. FIG. 4 shows the case where a reflection inspection and a transmission inspection are performed as inspections of two system types. Generally, the target light intensity (light quantity) of a light entering the image sensor 105 for transmission inspection differs in many cases from that of a light entering the image sensor 205 for reflection inspection. FIG. 4 shows the case where the target light intensity of the image sensor 105 for transmission inspection is larger than that of the image sensor 205 for reflection inspection. However, it is not limited thereto. The intensities may be vice versa, or be the same with each other. For example, when the dynamic range of outputs of the image sensor is defined by 256 gray scale levels, it is preferable to set the target light intensity such that, in transmission inspection, the white pattern being a high intensity light which transmits through the substrate 101, and in reflection inspection, the black pattern being a high intensity light which is reflected from the substrate 101 are individually about 200 gray scale levels. For example, the range from lower than the target light intensity by about 5 gray scale levels to higher than it by about 5 gray scale levels is set as the range of the target light intensity.

In FIG. 4, when an actual measured light intensity of the image sensor 105 for transmission inspection is higher than the range of the target light intensity and that of the image sensor 205 for reflection inspection is also higher than the range of the target light intensity (the upper part in FIG. 4), both of the actual measured light intensities can be adjusted to be within respective ranges of the target light intensities by reducing the transmittance of the ND filter 330. Furthermore, when an actual measured light intensity of the image sensor 105 for transmission inspection is close to the maximum value of the range of the target light intensity, and an actual measured light intensity of the image sensor 205 for reflection inspection is a little lower than the range of the target light intensity (the lower part in FIG. 4), the difference between both of the actual measured light intensities can be reduced and both of them can be adjusted to be within respective ranges of the target light intensities by adjusting the angle for the λ/2 wave plate 331 to an angle to increase the ratio of the inspection light for reflection inspection (or to decrease the ratio of the inspection light for transmission inspection).

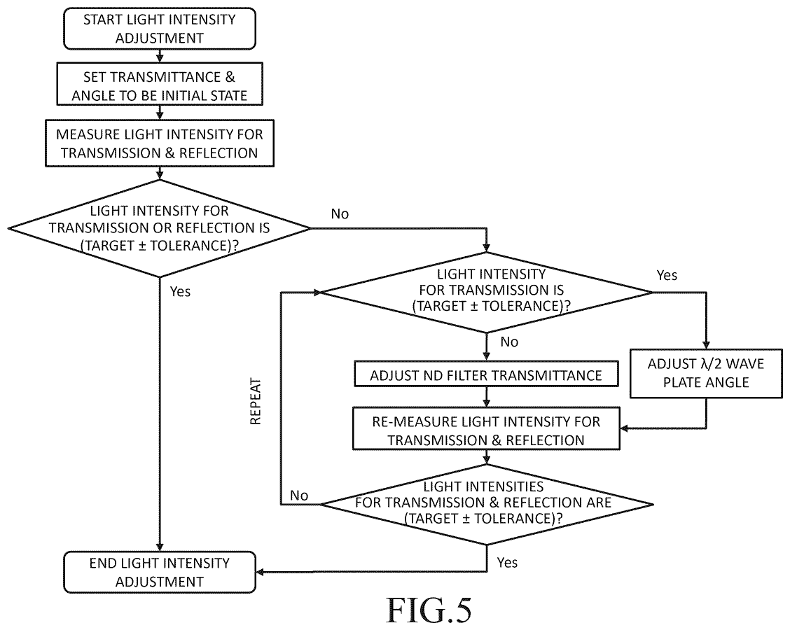

FIG. 5 is a flowchart of a light intensity adjustment method according to a comparative example of the first embodiment. In the comparative example, as shown in FIG. 5, first, the light intensity of the image sensor 105 for transmission inspection and that of the image sensor 205 for reflection inspection are measured. Next, it is determined whether each of the measured light intensities is within the range of the corresponding target light intensity. Then, when either of the both light intensities is not within the range of the corresponding target light intensity, it is determined whether the light intensity for transmission inspection is within the range of the target light intensity. If the light intensity for transmission inspection is not within the range of the target light intensity for transmission inspection, the transmittance of the ND filter 330 is adjusted so that the light intensity for transmission inspection may be within the range of the target light intensity for transmission inspection. Then, the light intensity of the image sensor 105 for transmission inspection and that of the image sensor 205 for reflection inspection are measured.

Again, it is determined whether each of the light intensity for transmission inspection and that for reflection inspection is within the range of the corresponding target light intensity. If the light intensity for transmission inspection is not within the range of the target light intensity for transmission inspection, adjustment of the transmittance of the ND filter 330 and measurement of the light intensity of the image sensor 105 for transmission inspection and that of the image sensor 205 for reflection inspection are repeated until the light intensity for transmission inspection is within the range of the target light intensity for transmission inspection.

Next, the angle for the λ/2 wave plate 331 is adjusted so that the light intensity for reflection inspection may be within the range of the target light intensity for reflection inspection. Then, the light intensity of the image sensor 105 for transmission inspection and that of the image sensor 205 for reflection inspection are measured. Then again, it is determined whether each of the light intensity for transmission inspection and that for reflection inspection is within the range of the corresponding target light intensity. Until each of the light intensity for transmission inspection and that for reflection inspection is within the range of the corresponding target light intensity, adjustment of the transmittance of the ND filter 330 is performed when the light intensity for transmission inspection is not within the range for transmission inspection, adjustment of the angle for the λ/2 wave plate 331 is performed when the light intensity for reflection inspection is not within the range for reflection inspection, and measurement of the light intensity of the image sensor 105 for transmission inspection and that of the image sensor 205 for reflection inspection are performed.

As described above, adjustment of the ND filter 330 and measurement of the light intensity of the image sensor 105 for transmission inspection and that of the image sensor 205 for reflection inspection at each time of the adjustment are repeated, and, besides, adjustment of the λ/2 wave plate 331 and measurement of the light intensity of the image sensor 105 for transmission inspection and that of the image sensor 205 for reflection inspection at each time of the adjustment are repeated. Thus, in the comparative example, the light intensity to be incident on each image sensor is adjusted by, while changing conditions, repeating setting an optical element and image-acquiring based on the setting, until desired conditions are obtained. Therefore, in the comparative example, the time for light intensity calibration processing takes long, and the setup time before inspection processing becomes long. Thereby, the inspection throughput is degraded.

Furthermore, since image acquisition performed a plurality of times repeatedly apply laser beams (lights) of high energy with a short wavelength to the substrate 101, patterns formed on the substrate 101 may be damaged. In light intensity calibration, in many cases, patterns formed on the substrate 101 for calibration are irradiated. Since the patterns for calibration may be used, for example, for calibration in a plurality of steps in semiconductor manufacturing, their being damaged poses a problem. Accordingly, in order to cope with this problem, it is needed to reduce the calibration processing time for the light intensity incident on each image sensor, and reduce the number of times of actual measuring.

Therefore, in the first embodiment, by obtaining the transmittance of the ND filter 330 and the adjustment angle for the λ/2 wave plate 331 by calculation, the transmittance of the ND filter 330, the number of times of adjusting the angle for the λ/2 wave plate 331, and the number of times of actual measuring light intensities for transmission inspection and reflection inspection are reduced. It is specifically described below.

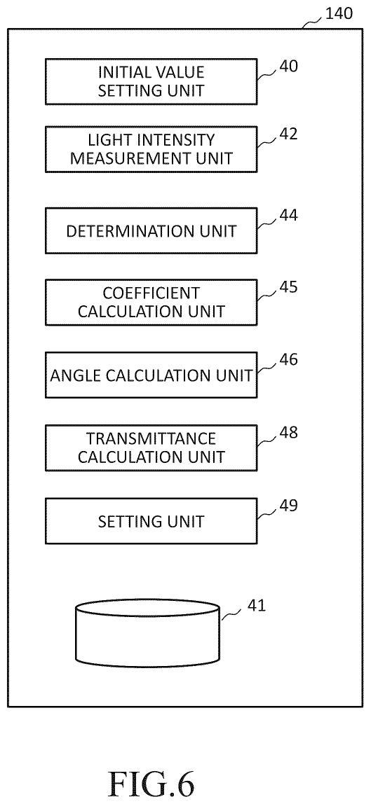

FIG. 6 is a block diagram showing an example of the internal configuration of a light intensity adjustment circuit according to the first embodiment. In FIG. 6, in the light intensity adjustment circuit 140, there are disposed a storage device 41 such as a magnetic disk drive, an initial value setting unit 40, a light intensity measurement unit 42, a determination unit 44, a coefficient calculation unit 45, an angle calculation unit 46, a transmittance calculation unit 48, and a setting unit 49. Each of the “ . . . units” such as the initial value setting unit 40, the light intensity measurement unit 42, the determination unit 44, the coefficient calculation unit 45, the angle calculation unit 46, the transmittance calculation unit 48, and the setting unit 49 includes processing circuitry. The processing circuitry includes, for example, an electric circuit, computer, processor, circuit board, quantum circuit, semiconductor device, or the like. Each “ . . . unit” may use common processing circuitry (the same processing circuitry), or different processing circuitry (separate processing circuitry). Input data necessary for the initial value setting unit 40, the light intensity measurement unit 42, the determination unit 44, the coefficient calculation unit 45, the angle calculation unit 46, the transmittance calculation unit 48, and the setting unit 49, and operated (calculated) results are stored in a memory (not shown) in the light intensity adjustment circuit 140, or the memory 111 each time.

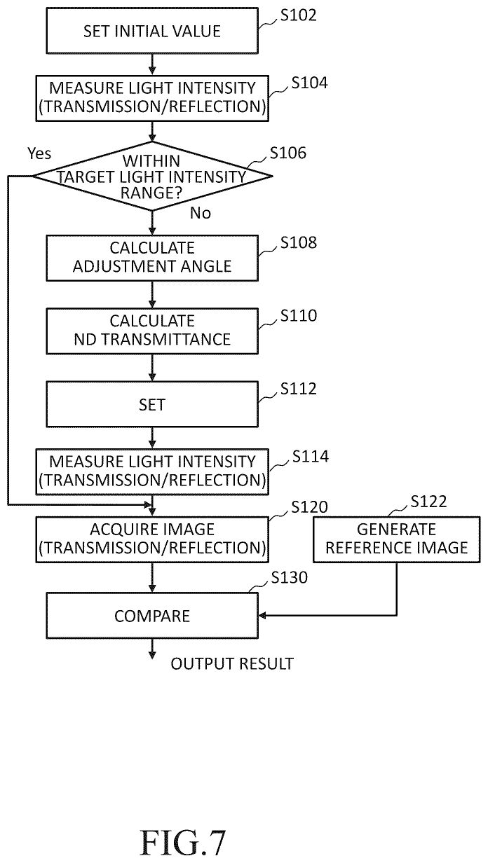

FIG. 7 is a flowchart showing an example of main steps of an inspection method according to the first embodiment. In FIG. 7, the inspection method of the first embodiment executes a series of steps: an initial value setting step (S102), a light intensity measurement step (S104), a determination step (S106), an adjustment angle calculation step (S108), an ND transmittance calculation step (S110), a setting step (S112), a light intensity measurement step (S114), an image acquisition step (S120), a reference image generation step (S122), a comparison step (S130). Among the steps described above, the light intensity calibration method of the first embodiment executes the initial value setting step (S102), the light intensity measurement step (S104), the determination step (S106), the adjustment angle calculation step (S108), the ND transmittance calculation step (S110), the setting step (S112), and the light intensity measurement step (S114).

In the initial value setting step (S102), the initial value setting unit 40 sets an initial value NDᵢₙᵢ of the transmittance ND to the ND filter 330. Also, the initial value setting unit 40 sets an initial value θᵢₙᵢ of the adjustment angle θ to the λ/2 wave plate 331.

In the light intensity measurement step (S104), the light intensity measurement unit 42 measures the light intensity entering the image sensor 105 for transmission inspection and that entering the image sensor 205 for reflection inspection in the state where the initial value NDᵢₙᵢ of the transmittance ND has been set to the ND filter 330 and the initial value θᵢₙᵢ of the adjustment angle θ has been set to the λ/2 wave plate 331.

In the case of no light coming from the light source 103, the measured light intensity is to be zero, but, there is a case where the measured light intensity is not zero at the minimum due to adjustment by the λ/2 wave plate 33. This corresponds to so-called black floating. In that case, the quantity between zero and the measured light intensity not being zero at the minimum is calculated in advance, and the calculated quantity is offset from the result measured by the light intensity sensor 130 or 230 at the time of light intensity measurement.

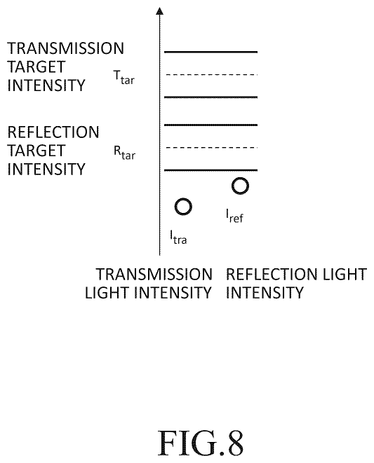

FIG. 8 is an illustration showing an example of a light intensity at an initial condition according to the first embodiment. In the light intensity measurement step (S104), it is specifically operated as follows. The light intensity measurement unit 42 outputs a command indicating that the light intensity sensor control circuit 142 should measure a light intensity. Under the control of the light intensity sensor control circuit 142, the drive mechanism 132 moves the light intensity sensor 130 to be on the optical axis. Similarly, under the control of the light intensity sensor control circuit 142, the drive mechanism 232 moves the light intensity sensor 230 to be in optical axis. Then, a laser beam is emitted from the light source 103 in the state where the initial value NDᵢₙᵢ of the transmittance ND has been set to the ND filter 330 and the initial value θᵢₙᵢ of the adjustment angle θ has been set to the λ/2 wave plate 331.

Thereby, the light intensity Iₜᵣₐ of the incident light (the first incident light), which was emitted from the light source 103 and enters the image sensor 105 via the ND filter 330, the λ/2 wave plate 331, the polarizing beam splitter 332, and the substrate 101 placed on the XYθ table 102, is measured by the light intensity sensor 130. A transmission light having passed through the substrate 101 irradiated with an inspection light (the first inspection light) being one of two lights generated by being branched by the polarizing beam splitter 332 enters the light intensity sensor 130, as the incident light (the first incident light) described above. The measured light intensity Iₜᵣₐ of the transmission light is output to the light intensity adjustment circuit 140, and stored in the storage device 41.

Similarly, the light intensity I_{ref} of the incident light (second incident light), which was emitted from the light source 103 and enters the image sensor 205 via the ND filter 330, the λ/2 wave plate 331, the polarizing beam splitter 332, and the substrate 101 placed on the XYθ table 102, is measured by the light intensity sensor 230. A reflection light reflected from the substrate 101 irradiated with an inspection light (the second inspection light) being the other one of the two lights generated by being branched by the polarizing beam splitter 332 enters the light intensity sensor 230, as the incident light (the second incident light) described above. The measured light intensity I_{ref} of the reflection light is output to the light intensity adjustment circuit 140, and stored in the storage device 41.

In the example of FIG. 8, each of the measured transmission light intensity Iₜᵣₐ and the measured reflection light intensity I_{ref} is less than the range of its target light intensity.

In the determination step (S106), the determination unit 44 determines whether each of the light intensity Iₜᵣₐ measured by light intensity sensor 130 and to be incident on the image sensor 105 for transmission inspection, and the light intensity I_{ref} measured by the light intensity sensor 230 and to be incident on the image sensor 205 for reflection inspection is within the range of its target light intensity. If both the light intensities are within the ranges of their respective target light intensities, determining that the light intensity calibration processing has been completed, it proceeds to the image acquisition step (S120). Unless both of them are within the ranges of their respective target light intensities, it proceeds to the adjustment angle calculation step (S108).

In the adjustment angle calculation step (S108), the angle calculation unit 46 calculates an adjustment angle θ_{adj} for the λ/2 wave plate 331 (½ wave plate) based on which the ratio between the light intensity of a transmission light (the first incident light) entering the light intensity sensor 130 and the light intensity of a reflection light (the second incident light) entering the light intensity sensor 230 becomes a desired ratio. The adjustment angle θ_{adj} is calculated by using a trigonometric function (the first trigonometric function) which defines a ratio of the light intensity of the transmission light entering the light intensity sensor 130 depending on the adjustment angle for the λ/2 wave plate 331 to the light intensity of the light entering the λ/2 wave plate 331, and a trigonometric function (the second trigonometric function) which defines a ratio of the light intensity of the reflection light entering the light intensity sensor 230 depending on the adjustment angle for the λ/2 wave plate 331 to the light intensity of the light entering the λ/2 wave plate 331. It is specifically described below.

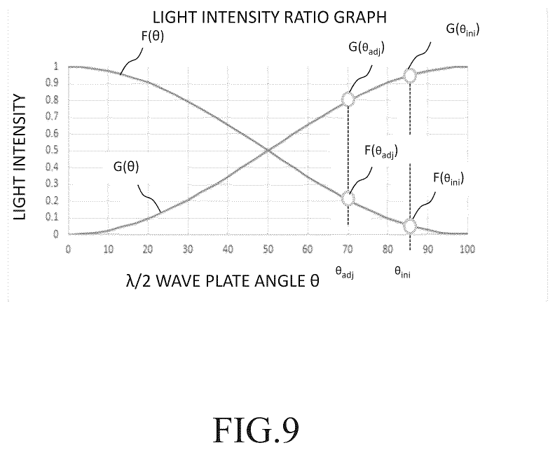

FIG. 9 is a graph showing an example of a relationship between a transmission light intensity ratio and a reflection light intensity ratio adjusted by the λ/2 wave plate according to the first embodiment. In FIG. 9, a transmission light intensity ratio F(θ) shows a ratio of the light intensity of a transmission light (first incident light) entering the light intensity sensor 130 depending on the adjustment angle for the λ/2 wave plate 331 to the light intensity of a light entering the λ/2 wave plate 331. A reflection light intensity ratio G(θ) shows a ratio of the light intensity of a reflection light (second incident light) entering the light intensity sensor 230 depending on the adjustment angle for the λ/2 wave plate 331 to the light intensity of a light entering the λ/2 wave plate 331. The transmission light intensity ratio F(θ) is defined by the cosine function (an example of the first trigonometric function) shown by the following equation (1-1) using a coefficient Kₜᵣₐ. The reflection light intensity ratio G(θ) is defined by the cosine function (an example of the second trigonometric function) shown by the following equation (1-2) using a coefficient K_{ref}.

$$F ( θ ) = {K}_{tra} ( COS θ + 1 ) \qquad ( 1 ‐ 1 )$$

$$G ( θ ) = {K}_{ref} ( - COS θ + 1 ) \qquad ( 1 ‐ 2 )$$

Using the half-angle formula of the trigonometric functions, the equations (1-1) and (1-2) can be converted into a cosine function (another example of the first trigonometric function) of the following equation (2-1), and a sine function (another example of the second trigonometric function) of the following equation (2-2).

$$F ( θ ) = 2 {K}_{tra} {\{ COS ( θ / 2 ) \}}^{2} \qquad ( 2 ‐ 1 )$$

$$G ( θ ) = 2 {K}_{ref} {\{ SIN ( θ / 2 ) \}}^{2} \qquad ( 2 ‐ 2 )$$

Now, if 2Kₜᵣₐ is redefined as Kₜᵣₐ, and 2K_{ref} is redefined as K_{ref}, the equations (2-1) and (2-2) can be converted into a cosine function (another example of the first trigonometric function) of the following equation (3-1), and a sine function (another example of the second trigonometric function) of the following equation (3-2). The coefficient Kₜᵣₐ is defined by the equation (3-3), and the coefficient K_{ref} is defined by the equation (3-4).

$$F ( θ ) = {K}_{t r a} {\{ COS ( θ / 2 ) \}}^{2} \qquad ( 3 ‐ 1 )$$

$$G ( θ ) = {K}_{ref} {\{ SIN ( θ / 2 ) \}}^{2} \qquad ( 3 ‐ 2 )$$

$${K}_{t r a} = 1 - {T}_{min} / {T}_{max} \qquad ( 3 ‐ 3 )$$

$${K}_{ref} = 1 - {R}_{min} / {R}_{max} \qquad ( 3 ‐ 4 )$$

Here, the light intensity Tₘₐₓ indicates the light intensity measured by the light intensity sensor 130 in the state where the angle for the λ/2 wave plate 331 has been set such that the transmission light intensity is maximum (100%). The light intensity Tₘᵢₙ indicates the light intensity measured by the light intensity sensor 130 in the state where the angle for the λ/2 wave plate 331 has been set such that the transmission light intensity is minimum (0%). The light intensity Rₘₐₓ indicates the light intensity measured by the light intensity sensor 230 in the state where the angle for the λ/2 wave plate 331 has been set such that the reflection light intensity is maximum (100%). The light intensity Rₘᵢₙ indicates the light intensity measured by the light intensity sensor 230 in the state where the angle for the λ/2 wave plate 331 has been set such that the reflection light intensity is minimum (0%).

In the case of no light coming from the light source 103, the measured light intensity is to be zero, but, there is a case where the measured light intensity is not zero at the minimum due to adjustment by the λ/2 wave plate 33. This corresponds to so-called black floating. In that case, the quantity between zero and the measured light intensity not being zero at the minimum is offset at the side of the light intensity sensor 130 or 230. Here, the coefficient Kₜᵣₐ or K_{ref} acts as the gain. The light intensities Tₘₐₓ, Tₘᵢₙ, Rₘₐₓ, and Rₘᵢₙ are beforehand measured as apparatus-specific values.

FIG. 9 shows the cosine function F(θ) defined by the equation (3-1), and the sine function G(θ) defined by the equation (3-2), where both the functions are depending on the adjustment angle θ. Information on the cosine function F(θ) defined by the equation (3-1), and the sine function G(θ) defined by the equation (3-2), both the functions being depending on the adjustment angle θ, is beforehand stored in the storage device 41.

In other words, the trigonometric function (the first trigonometric function) for calculating the transmission light intensity ratio F(θ) is defined by the cosine function (the right-hand side of the equation (3-1)) using the coefficient Kₜᵣₐ (the first coefficient) which is calculated using the light intensity measured by the light intensity sensor 130 (the first light intensity sensor) in the state where the angle for the λ/2 wave plate 331 has been set such that the transmission light intensity is maximum, and the light intensity measured by the light intensity sensor 130 in the state where the angle for the λ/2 wave plate 331 has been set such that the transmission light intensity is minimum. The trigonometric function (the second trigonometric function) for calculating the reflection light intensity ratio G(θ) is defined by the sine function (the right-hand side of the equation (3-2)) using the coefficient K_{ref} (the second coefficient) which is calculated using the light intensity measured by the light intensity sensor 230 (the second light intensity sensor) in the state where the angle for the λ/2 wave plate 331 has been set such that the reflection light intensity is maximum, and the light intensity measured by the light intensity sensor 230 in the state where the angle for the λ/2 wave plate 331 has been set such that the reflection light intensity is minimum.

The light intensity T_{adj} of a transmission light (the first incident light) based on the adjustment angle θ_{adj} having been adjusted from the initial angle θᵢₙᵢ of the angle θ of the λ/2 wave plate 331 can be calculated by multiplying the initial light intensity Iₜᵣₐ by a value obtained by dividing the transmission light intensity ratio F(θ_{adj}) based on the adjustment angle θ_{adj} by the transmission light intensity ratio F(θᵢₙᵢ) based on the initial angle θᵢₙᵢ. Similarly, the light intensity R_{adj} of a reflection light (the second incident light) having been adjusted can be calculated by multiplying the initial light intensity I_{ref} by a value obtained by dividing the reflection light intensity ratio G(θ_{adj}) based on the adjustment angle θ_{adj} by the reflection light intensity ratio G(θᵢₙᵢ) based on the initial angle θᵢₙᵢ. By adjusting the angle θ of the λ/2 wave plate 331 from the initial angle θᵢₙᵢ to the adjustment angle θ_{adj}, the ratio between the light intensity T_{adj} of the adjusted transmission light (the first incident light) and the light intensity R_{adj} of the adjusted reflection light (the second incident light) is set to be the same as the ratio between the target light intensity Tₜₐᵣ of a transmission light (the first incident light) and the target light intensity Rₜₐᵣ of a reflection light (the second incident light). Such a relationship can be defined by the following equation (4).

$${R}_{a d j} / {T}_{a d j =} [ {I}_{r e f} \times G ( {θ}_{a d j} ) / G ( {θ}_{i n i} ) ] / [ {I}_{t r a} \times F ( {θ}_{a d j} ) / F ( {θ}_{i n i} ) ] = {R}_{t a r} / {T}_{t a r} \qquad ( 4 )$$

The ratio between the target light intensity Tₜₐᵣ and the target light intensity Rₜₐᵣ is defined the equation (5).

$${R}_{tar} / {T}_{tar} = α ( {I}_{t r a} / {I}_{ref} ) \qquad ( 5 )$$

Using the relationship of the equation (5), the equation (4) can be transformed into the equation (6).

$$G ( {θ}_{a d j} ) / F ( {θ}_{a d j} ) = α \{ G ( {θ}_{i n i} ) / F ( {θ}_{i n i} ) \} \qquad ( 6 )$$

Therefore, an unknown adjustment angle θ_{adj} can be defined by the following equation (7).

$${θ}_{a d j} = 2 {tan}^{- 1} \{ tan ( {θ}_{i n i} / 2 ) \} \times √ α \qquad ( 7 )$$

First, the coefficient calculation unit 45 calculates a coefficient α by the equation (5). Then, the angle calculation unit 46 calculates an adjustment angle θ_{adj} by the equation (7).

In the ND transmittance calculation step (S110), the transmittance calculation unit 48 calculates a transmittance ND_{adj} of the ND filter 330 based on which the light intensity of a transmission light entering the light intensity sensor 130 becomes a value within the range of a target light intensity for transmission inspection, the range being set for the light intensity sensor 130 in advance and the light intensity of a reflection light entering the light intensity sensor 230 becomes a value within the range of a target light intensity for reflection inspection, the range being set for the light intensity sensor 230 in advance. The transmittance ND_{adj} is calculated by using a calculated adjustment angle θ_{adj}. For example, it is preferable to set the range of the target light intensity to ±10% of the target light intensity. Specifically, the transmittance ND_{adj} of the ND filter 330 is calculated by using one of a ratio and a statistic value, the ratio being a ratio between a predetermined target light intensity and one of a light intensity of a transmission light entering the light intensity sensor 130 and a light intensity of a reflection light entering the light intensity sensor 230, both being in a case where the λ/2 wave plate 331 has been adjusted based on the calculated adjustment angle θ_{adj}, the statistic value being obtained by using the light intensity of the transmission light and the light intensity of the reflection light. It is further specifically described below.

The transmittance ND_{adj} can be calculated, for example, by multiplying the initial value NDᵢₙᵢ of the transmittance of the ND filter 330 by a ratio between the target light intensity Tₜₐᵣ of a transmission light and the transmission light intensity T_{adj} having been adjusted. That is, the transmittance ND_{adj} can be defined by the following equation (8) using the adjusted transmission light intensity T_{adj}. As described above, the transmission light intensity T_{adj} is calculated by multiplying the initial light intensity Iₜᵣₐ by a value obtained by dividing the transmission light intensity ratio F(θ_{adj}) based on the adjustment angle θ_{adj} (calculated adjustment angle) by the transmission light intensity ratio F(θᵢₙᵢ) based on the initial angle θᵢₙᵢ.

$$N {D}_{adj} = N {D}_{i n i} \times {T}_{tar} / \{ {I}_{t r a} \times F ( {θ}_{a d j} ) / F ( {θ}_{i n i} ) \} \qquad ( 8 )$$

Alternatively, the transmittance ND_{adj} can be calculated, for example, by multiplying the initial value NDᵢₙᵢ of the transmittance of the ND filter 330 by a ratio between the target light intensity Rₜₐᵣ of a reflection light and the reflection light intensity R_{adj} having been adjusted. That is, the transmittance ND_{adj} can be defined by the following equation (9) using an adjusted reflection light intensity R_{adj}, for example. As described above, the reflection light intensity R_{adj} can be calculated by multiplying the initial light intensity I_{ref} by a value obtained by dividing the reflection light intensity ratio G(θ_{adj}) based on the adjustment angle θ_{adj} by the reflection light intensity ratio G(θᵢₙᵢ) based on the initial angle θᵢₙᵢ.

$${ND}_{a d j} = {ND}_{i n i} \times {R}_{t a r} / \{ {I}_{r e f} \times G ( {θ}_{a d j} ) / G ( {θ}_{i n i} ) \} \qquad ( 9 )$$

Alternatively, it is also preferable to obtain the transmittance ND_{adj} as a statistic value, such as an average value, of each transmittance ND_{adj} described above. It can be defined by the following equation (10).

$${ND}_{a d j} = {ND}_{i n i} \times [ {T}_{t a r} / \{ {I}_{t r a} \times F ( {θ}_{a d j} ) / F ( {θ}_{i n i} ) \} + {R}_{t a r} / \{ {I}_{ref} \times G ( {θ}_{a d j} ) / G ( {θ}_{i n i} ) \} ] / 2 \qquad ( 10 )$$

In the setting step (S112), the setting unit 49 sets the ND filter 330 to have a calculated transmittance ND_{adj}. Furthermore, the setting unit 49 sets a calculated adjustment angle θ_{adj} to the λ/2 wave plate 331.

In the light intensity measurement step (S114), in the state where the transmittance ND_{adj} has been set to the ND filter 330 and the adjustment angle θ_{adj} has been set for the λ/2 wave plate 331, the light intensity measurement unit 42 measures the light intensity incident on the image sensor 105 for transmission inspection, and that incident on the image sensor 205 for reflection inspection. The method of measuring a light intensity is the same as that described above. Since this measurement is a step for verifying a calculated result, it may be omitted.

In this way, light intensity calibration processing is performed. Thereby, each of the light intensity entering the image sensor 105 for transmission inspection and the light intensity entering the image sensor 205 for reflection inspection can be within the range of its target light intensity. After the light intensity calibration processing, the light intensity measurement unit 42 outputs a command indicating that light intensity measurement is completed to the light intensity sensor control circuit 142. Under the control of the light intensity sensor control circuit 142, the drive mechanism 132 moves the light intensity sensor 130 to the outside of the optical axis. Similarly, under the control of the light intensity sensor control circuit 142, the drive mechanism 232 moves the light intensity sensor 230 to the outside of the optical axis. Then, inspection processing is to be performed.

In the image acquisition step (S120), using the image sensor 105 (205) for which light intensity calibration has been performed, the optical image acquisition mechanism 150 acquires an image of the substrate 101, and outputs data of the acquired optical image. Concretely, first, the optical image acquisition mechanism 150 individually scans a transmission inspection light and a reflection inspection light over the inspection stripe 20 in order to acquire, for each inspection stripe 20, an image of the stripe region by the image sensor 105 (205). Specifically, it operates as follows. The XYθ table 102 is moved to the position at which a target inspection stripe 20 can be acquired.

Then, the light intensity of a light emitted from the light source 103 is attenuated by the ND filter 330 for which the transmittance ND_{adj} has been set. The polarization direction of the light having passed through the ND filter 330 is adjusted by the λ/2 wave plate 331 where the adjustment angle θ_{adj} has been set. The laser beam 301 whose polarization direction has been adjusted is branched according to a polarization direction by the polarizing beam splitter 332, thereby generating two inspection lights, a P wave component light and an S wave component light, for example.

In transmission inspection, the image sensor 105 (the first image sensor) acquires an optical image (the first optical image) of the substrate 101 which is irradiated with an inspection light (the first inspection light) being one of two lights generated because of being branched, by the polarizing beam splitter 332, from the light having passed through the ND filter 330 for which a calculated transmittance ND_{adj} has been set, and the λ/2 wave plate 331 where a calculated adjustment angle θ_{adj} has been set.

A pattern image focused/formed on the image sensor 105 is photoelectrically converted by each photo sensor element of the image sensor 105, and further, analog-to-digital (A/D) converted by the sensor circuit 106. The gray scale value (image data) of each pixel is output to the stripe pattern memory 123 to be stored temporarily. Measurement data (pixel data) of the inspection stripe 20 being an inspection target stored in the stripe pattern memory 123 is, for example, 8-bit unsigned data, and indicates a gray scale level of brightness (light intensity) of each pixel. Data of the pixel value of the inspection stripe 20 is output to the comparison circuit 108.

In reflection inspection, the image sensor 205 (the second image sensor) acquires an optical image (the second optical image) of the substrate 101 which is irradiated with an inspection light (the second inspection light) being the other one of the two lights generated because of being branched, by the polarizing beam splitter 332, from the light having passed through the ND filter 330 for which a calculated transmittance ND_{adj} has been set, and the λ/2 wave plate 331 where a calculated adjustment angle θ_{adj} has been set.

A pattern image focused/formed on the image sensor 205 is photoelectrically converted by each photo sensor element of the image sensor 205, and further, analog-to-digital (A/D) converted by the sensor circuit 206. The gray scale value (image data) of each pixel is output to the stripe pattern memory 223 to be stored temporarily. Measurement data (pixel data) of the inspection stripe 20 being an inspection target stored in the stripe pattern memory 223 is, for example, 8-bit unsigned data, and indicates a gray scale level of brightness (light intensity) of each pixel. Data of the pixel value of the inspection stripe 20 is output to the comparison circuit 108.

In the reference image generation step (S122), the reference image generation circuit 112 generates, using figure pattern data (design data), a reference image serving as a reference. Generating a reference image is carried out, for each inspection stripe 20, in parallel to scanning the inspection stripe 20 concerned. Specifically, it operates as follows: The reference image generation circuit 112 inputs figure pattern data (design data) with respect to each frame region 30 of the target inspection stripe 20, and converts each figure pattern defined by the input figure pattern data into image data in binary or multiple values.

Basic figures defined by the figure pattern data are, for example, rectangles and triangles. For example, figure data which defines the shape, size, position, and the like of each pattern figure is stored by using information, such as coordinates (x, y) of a reference position of the figure, lengths of sides of the figure, and a figure code serving as an identifier for identifying the figure type such as rectangles and triangles.

When design pattern data used as the figure data is input to the reference image generation circuit 112, the data is developed into data of each figure. Then, the figure code, the figure dimensions, and the like indicating the figure shape of each figure data are interpreted. Then, the reference image generation circuit 112 develops each figure data to design pattern image data in binary or multiple values as a pattern to be arranged in squares in units of grids of predetermined quantization dimensions, and outputs the developed data. In other words, the reference image generation circuit 112 reads design data, calculates an occupancy rate of the figure in the design pattern, for each square region obtained by virtually dividing the frame region into squares in units of predetermined dimensions, and outputs n-bit occupancy data (design image data). For example, it is preferable to set one square as one pixel. Assuming that one pixel has a resolution of ½⁸(= 1/256), the occupancy rate in each pixel is calculated by allocating sub-regions, each having 1/256 resolution, which correspond to the region of a figure arranged in the pixel. It is generated as 8-bit occupancy data. Such square regions (inspection pixels) can be corresponding to (commensurate with) pixels of measured data.

Next, the reference image generation circuit 112 performs filtering processing, using a filter function, on design image data of a design pattern being image data of a figure.

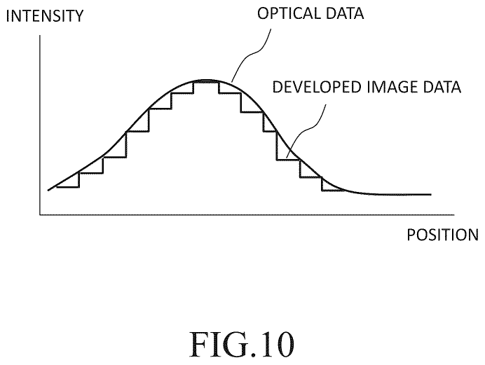

FIG. 10 is a diagram illustrating filter processing according to the first embodiment. Since pixel data of an optical image acquired from the substrate 101 is in a state affected by filtering due to resolution characteristics etc. of the optical system used for image acquisition, in other words, in an analog state continuously changing, as shown in FIG. 10, for example, the optical image is different from the developed image (design image) whose image intensity (gray scale value) is represented by digital values. By contrast, in figure pattern data, since pattern codes, etc. are used for defining as described above, image intensity (gray scale level) of developed design images may be digital values. Accordingly, the reference image generation circuit 112 performs image processing (filter processing) on the developed image in order to generate a reference image quality-wise close to the optical image. Thereby, it is possible to match design image data being design side image data, whose image intensity (gray scale level) is in digital values, with image generation characteristics of measured data (optical image). The generated reference image is output to the comparison circuit 108.

Now, a reference image for transmission inspection and a reference image for reflection inspection are generated. Comparing the reference image for transmission inspection and that for reflection inspection, black and white of a pattern are reversed, for example.

In the comparison step (S130), the comparison circuit unit 144 compares an optical image (the first optical image) for transmission inspection with a reference image (the first predetermined image) for transmission inspection, and compares an optical image (the second optical image) for reflection inspection with a reference image (the second predetermined image) for reflection inspection.

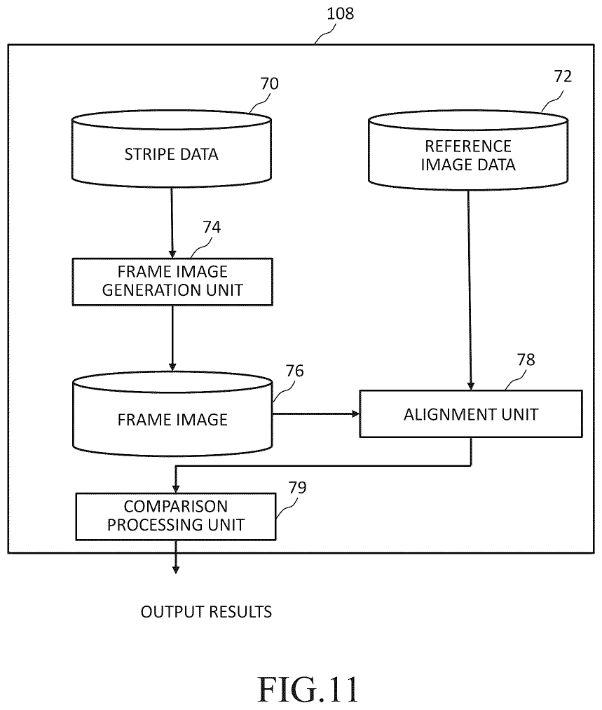

FIG. 11 is an illustration showing an example of the internal configuration of a comparison circuit according to the first embodiment. As shown in FIG. 11, in each comparison circuit 108, there are disposed storage devices 70, 72, and 76 such as magnetic disk drives, a frame image generation unit 74, an alignment unit 78, and a comparison processing unit 79. Each of the “units” such as the frame image generation unit 74, the alignment unit 78, and the comparison processing unit 79 includes processing circuitry. The processing circuitry includes, for example, an electric circuit, computer, processor, circuit board, quantum circuit, semiconductor device, or the like. Common processing circuitry (the same processing circuitry), or different processing circuitry (separate processing circuitry) may be used for each of the “ . . . units”. Input data needed in the frame image generation unit 74, the alignment unit 78, and the comparison processing unit 79, and calculated (operated) results are stored in a memory (not shown) in the comparison circuit 108 or in the memory 111 each time.

In a plurality of comparison circuits 108a and 108b of the same configuration, transmission inspection is performed in the comparison circuit 108a, and reflection inspection is performed in the comparison circuit 108b. Alternatively, both the transmission inspection and the reflection inspection may be performed in the comparison circuit 108 only.

Stripe data (stripe region image) input to the comparison circuit 108a (108b) is stored in the storage device 70. Reference image data input to the comparison circuit 108 is stored in the storage device 72.

In the comparison circuit 108, first, the frame image generation unit 74 generates a plurality of frame images 31 by dividing the stripe region image (optical image) by a predetermined width. Specifically, as shown in FIG. 2, a stripe region image is divided into frame images of a plurality of rectangular frame regions 30. For example, it is divided into the size of 1024×1024 pixels. Data of each frame region 30 is stored in the storage device 76.

Next, the alignment unit 78 reads, for each frame region 30, a corresponding frame image 31 and a corresponding reference image from the storage devices 72 and 76, and performs alignment (position adjustment) of the frame image 31 and the corresponding reference image based on a predetermined algorithm. For example, the alignment is performed by the least-square method.

The comparison processing unit 79 (another example of the comparison unit) compares the frame image 31 with the reference image corresponding to the frame image 31 concerned. For example, comparing is performed for each pixel. Here, the comparison processing unit 79 compares, for each pixel, both the images based on predetermined determination conditions so as to determine whether there is a defect, such as a shape defect, or not. For example, based on predetermined algorithm as the determination conditions, both the images are compared with each other for each pixel to determine whether there is a defect or not. For example, for each pixel, a difference value between pixel values of the optical image and the reference image is calculated, and it is determined there is a defect when the difference value is larger than a threshold Th. Then, the comparison result is output to, for example, the magnetic disk drive 109, or a pattern monitor (not shown), or alternatively, output from a printer (not shown).

Although the case of performing the die-to-database inspection is described in the above example, the die-to-die inspection may also be used. In that case, with respect to frame regions of dies 1 and 2 for the die-to-die inspection, the comparison circuit 108 uses a frame image (optical image) of the die 2, as a reference (reference image). First, for each frame region 30 to which the die-to-die inspection is performed, the alignment unit 78 reads the frame image 31 of the die 1 and a corresponding frame image of the die 2 from the storage device 76, and performs alignment between the frame image 31 of the die 1 and the frame image of the die 2 based on a predetermined algorithm. For example, the alignment is performed according to the least-square method. Then, for each frame region 30 to which the die-to-die inspection is performed, the comparison processing unit 79 (comparison unit) compares, for each pixel, the frame image 31 of the die 1 with the corresponding frame image of the die 2.

As described above, according to the first embodiment, it is possible to greatly reduce the number of times of light intensity measurement, and the number of times of adjustment of the ND filter 330 and the λ/2 wave plate 331. Accordingly, for example, a calibration processing time for a light intensity (light quantity) incident on an image sensor of each system, such as transmission inspection and reflection inspection, can be reduced.

Embodiments have been explained referring to specific examples described above. However, the present invention is not limited to these specific examples.

While the apparatus configuration, control method, and others not directly necessary for explaining the present invention are not described, some or all of them can be appropriately selected and used on a case-by-case basis when needed. For example, although description of the configuration of the control unit for controlling the inspection apparatus 100 is omitted, it should be understood that some or all of the configuration of the control unit can be selected and used appropriately when necessary.

Furthermore, any other pattern inspection apparatus and pattern inspection method that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern inspection apparatus comprising:
a stage configured to place thereon a target object on which a pattern is formed;
a light source;
a neutral density filter configured to attenuate a light intensity of a light emitted from the light source to any level;
a ½ wave plate configured to adjust a polarization direction of a light having passed through the neutral density filter;
a branch element configured to branch a light having passed through the ½ wave plate;
a first image sensor configured to acquire a first optical image of the target object which is irradiated with a first inspection light being one of two lights generated because of being branched;
a second image sensor configured to acquire a second optical image of the target object which is irradiated with a second inspection light being another one of the two lights generated because of being branched;
a first light intensity sensor configured to measure a light intensity of a first incident light entering the first image sensor;
a second light intensity sensor configured to measure a light intensity of a second incident light entering the second image sensor;
an angle calculation circuit configured to calculate an adjustment angle for the ½ wave plate based on which a ratio between a light intensity of the first incident light entering the first light intensity sensor and a light intensity of the second incident light entering the second light intensity sensor becomes a desired ratio;
a transmittance calculation circuit configured to calculate a transmittance of the neutral density filter based on which a light intensity of the first incident light entering the first light intensity sensor becomes a value within a desired range set for the first light intensity sensor and a light intensity of the second incident light entering the second light intensity sensor becomes a value within a desired range set for the second light intensity sensor; and
a comparison circuit configured to compare the first optical image with a first predetermined image, and compare the second optical image with a second predetermined image.

2. The apparatus according to claim 1, wherein
the first optical image is acquired using the first inspection light being one of two lights generated because of being branched from a light having passed through the neutral density filter for which a calculated transmittance has been set and the ½ wave plate where a calculated adjustment angle has been set, and
the second optical image is acquired using the second inspection light being another one of the two lights generated because of being branched from the light having passed through the neutral density filter for which the calculated transmittance has been set and the ½ wave plate where the calculated adjustment angle has been set.

3. The apparatus according to claim 1, wherein
a transmission light having passed through the target object which is irradiated with the first inspection light enters the first light intensity sensor, and
a reflection light reflected from the target object which is irradiated with the second inspection light enters the second light intensity sensor.

4. The apparatus according to claim 1, wherein the transmittance is calculated using a calculated adjustment angle.

5. The apparatus according to claim 1, wherein
the adjustment angle is calculated by using a first trigonometric function which defines a ratio of a light intensity of the first incident light entering the first light intensity sensor depending on an adjustment angle for the ½ wave plate to a light intensity of a light entering the ½ wave plate, and a second trigonometric function which defines a ratio of a light intensity of the second incident light entering the second light intensity sensor depending on the adjustment angle for the ½ wave plate to the light intensity of the light entering the ½ wave plate, and
the transmittance is calculated by using one of a ratio and a statistic value, the ratio being a ratio between a predetermined target light intensity and one of a light intensity of the first incident light entering the first light intensity sensor and a light intensity of the second incident light entering the second light intensity sensor, both being in a case where the ½ wave plate has been adjusted based on a calculated adjustment angle, the statistic value being obtained by using the light intensity of the first incident light and the light intensity of the second incident light.

6. The apparatus according to claim 5, wherein, as the statistic value, an average value is used.

7. The apparatus according to claim 5, wherein,
the first trigonometric function is defined by a cosine function using a first coefficient which is calculated using a light intensity measured by the first light intensity sensor in a state where an angle for the ½ wave plate has been set such that a transmission light intensity is maximum, and a light intensity measured by the first light intensity sensor in a state where the angle for the ½ wave plate has been set such that a transmission light intensity is minimum.

8. The apparatus according to claim 5, wherein,
the second trigonometric function is defined by a sine function using a second coefficient which is calculated using a light intensity measured by the second light intensity sensor in a state where an angle for the ½ wave plate has been set such that a reflection light intensity is maximum, and a light intensity measured by the second light intensity sensor in a state where the angle for the ½ wave plate has been set such that a reflection light intensity is minimum.

9. The apparatus according to claim 4, wherein,
the transmittance is calculated by multiplying an initial value of the transmittance of the neutral density filter by a ratio between a target light intensity of a transmission light and an adjusted transmission light intensity, and
the adjusted transmission light intensity is calculated by multiplying an initial light intensity of a transmission light by a value obtained by dividing a transmission light intensity ratio based on a calculated adjustment angle by a transmission light intensity ratio based on an initial angle.

10. A pattern inspection method comprising:
attenuating, using a neutral density filter, a light intensity of a light emitted from a light source to any level;
adjusting, using a ½ wave plate, a polarization direction of a light having passed through the neutral density filter;
branching, using a branch element, a light having passed through the ½ wave plate;
measuring, using a first light intensity sensor, a light intensity of a first incident light which was emitted from the light source and enters a first image sensor via the neutral density filter, the ½ wave plate, the branch element, and a target object, placed on a stage, with a formed pattern;
measuring, using a second light intensity sensor, a light intensity of a second incident light which was emitted from the light source and enters a second image sensor via the neutral density filter, the ½ wave plate, the branch element, and the target object;
calculating an adjustment angle for the ½ wave plate based on which a ratio between a light intensity of the first incident light entering the first light intensity sensor and a light intensity of the second incident light entering the second light intensity sensor becomes a desired ratio;
calculating a transmittance of the neutral density filter based on which a light intensity of the first incident light entering the first light intensity sensor becomes a value within a desired range set for the first light intensity sensor and a light intensity of the second incident light entering the second light intensity sensor becomes a value within a desired range set for the second light intensity sensor;
acquiring, using the first image sensor, a first optical image of the target object irradiated with a first inspection light being one of two lights generated because of being branched, by the branch element, from a light having passed through the neutral density filter for which a calculated transmittance has been set and the ½ wave plate where a calculated adjustment angle has been set;
acquiring, using the second image sensor, a second optical image of the target object irradiated with a second inspection light being another one of the two lights generated because of being branched, by the branch element, from the light having passed through the neutral density filter for which the calculated transmittance has been set and the ½ wave plate where the calculated adjustment angle has been set; and
comparing the first optical image with a first predetermined image, and the second optical image with a second predetermined image, and outputting a result.
